(19) United States
(12) Patent Application Publication
(10) Pub. No.: US 2003/0177747 A1
(43) Pub. Date: Sep. 25, 2003

(54) Wheel mounting apparatus

(76) Inventors: Trevor Lundstom, Kewdale (AU); David Lundstrom, Yokine (AU)

Correspondence Address: GREENBLUM & BERNSTEIN, P.L.C., 1950 ROLAND CLARKE PLACE, RESTON, VA, 20191, US

(21) Appl. No.: 10/312,553

(22) PCT Filed: Jun. 8, 2001
(86) PCT No.: PCT/AU01/00689

(51) Int. Cl. A01D 34/00

(52) U.S. Cl. 56/229

(57) ABSTRACT

A mounting arrangement for wheels (18) of elongate equipment such as a thresher (10), the wheels (18) being mountable distally in either trailing configuration or an in-line configuration when the thresher (10) is deployed, the wheels (18) also being mountable proximally to make the thresher (10) a narrower for transport through gates and along roads. A mounting arrangement is provided for one of the wheels (18) to rotate it to align with the required direction of travel, while a further mounting arrangement is provided to allow the other wheel (18) to be moved to or near an adjacent corner, to achieve conversion between the distal and proximal arrangements. There is provision for height adjustment of the thresher (10) relative to the ground, provided in the mounting arrangements.

### FIELD OF THE INVENTION

The present invention relates to a mounting arrangement. More particularly, the mounting arrangement of the present invention is intended for use in the mounting of wheels to items of machinery that are to be towed in greater than one configuration.

### BACKGROUND ART

Many items of agricultural and industrial machinery are towed behind tractors, trucks, or similar vehicles. When operating these items of machinery, for example scarifiers, seeders or threshing machines they are generally oriented transversely with respect to the direction of travel so as to expose their full width during operation. Often this full width makes transport of that machinery difficult, impractical or even impossible on normal roadways and through other obstacles, including gates. As such, it is desirable to be able to alter the configuration of the machinery in an efficient manner for transport on such roadways and through gates and the like.

Further, such items of machinery typically operate in a “wheels-trailing” orientation in which the wheels supporting the machinery are arranged such that they trail the operative portion of the machinery. For example, such is typical of prior art threshing machines. This arrangement does not generally allow fine control of the rotor height relative to the crop or stubble in which it is working. As such, it is seen as preferable to provide a mounting arrangement for the wheels of such a machine in which the wheels may be arranged whereby they are effectively “in-line” with the rotor of the threshing machine, whilst also allowing the typical “wheels-trailing” position to be adopted if desired.

Throughout the specification, unless the context requires otherwise, the word “comprise” or variations such as “comprises” or “comprising”, will be understood to imply the inclusion of a stated integer or group of integers but not the exclusion of any other integer or group of integers.

### DISCLOSURE OF THE INVENTION

In accordance with the present invention there is provided a mounting arrangement comprising at least one plate hingedly connected to an article of machinery, the plate having attached thereto a wheel support arm in a releasable and adjustable manner, the plate being able to pivot with respect to the article of machinery such that the orientation of the wheel arm with respect thereto may be altered and fixed in one of at least two differing positions.

The means by which the wheel arm is attached to the plate is preferably adjustable so as to allow the height of the article of machinery to be adjusted thereby.

The means by which the wheel arm is attached to the plate is preferably incrementally adjustable so as to allow the height of the article of machinery to be adjusted thereby.

In accordance with the present invention there is further provided a mounting arrangement comprising at least one plate to which is attached a wheel support arm in a releasable and adjustable manner, the orientation of the wheel arm with respect to the bracket being able to be adjusted so as to allow the wheel arm to be adjusted between both a “wheels-trailing” orientation and a “wheels in-line” orientation.

Preferably, when the wheel support arm is arranged so as to provide the “wheels in-line” orientation an additional support means is provided, this support means also operating to fix the wheel support arm at a particular height so as to allow adjustment of the height of the article of machinery with respect to a surface over which it is passing.

The additional support means preferably comprises a pair of vertically adjustable (preferably incrementally adjustable) brackets in between which the wheels support arm may be held.

Also in accordance with the invention there Is provided an elongate article of machinery supported from the ground on at least two wheels, said machinery having a mounting arrangement located at or near one corner thereof, for receiving a wheel arm which may be oriented and fixed in one of at least two different positions, and a mounting arrangement mountable at or near each adjacent corner for receiving a second wheel arm, where said machinery may be deployed with said wheel arm and said second wheel arm located distally, and said machinery may be transported with said wheel arm and said second wheel arm located proximally.

### BRIEF DESCRIPTION OF THE DRAWINGS

The mounting arrangement of the present invention will now be described, by way of example only, with respect to one embodiment thereof and the accompanying drawings, in which:-

FIG. 1 is a top plan view of a threshing machine on which the mounting arrangement of the present invention has been provided, showing the threshing machine in the transverse or operating orientation with the wheels thereof in the “wheels-trailing” orientation or arrangement;

FIG. 2 is a side elevational view of the threshing machine of FIG. 1, showing in detail the mounting arrangement;

FIG. 3 a rear elevational view of the threshing machine and mounting arrangement of FIGS. 1 and 2;

FIG. 4 is a top plan view of the threshing machine of FIG. 1, showing the wheels and mounting arrangement in the “wheels in-line” orientation or arrangement whilst the threshing machine is towed in its operational orientation;

FIG. 5 is a side elevational view of the threshing machine of FIG. 4 showing clearly the modified or adjusted mounting arrangement;

FIG. 6 is a rear elevational view of the threshing machine of FIGS. 4 and 5;

FIG. 7 is a top plan view of the threshing machine of FIGS. 1 and 4, showing the threshing machine in a road transport orientation in which the machine is oriented longitudinally with respect to the direction of travel;

FIG. 8 is a rear elevational view of the threshing machine of FIG. 7; and

FIG. 9 is a side elevational view of the threshing machine of FIGS. 7 and 8, showing clearly the modified or adjusted mounting apparatus.

### BEST MODE(S) FOR CARRYING OUT THE INVENTIONB

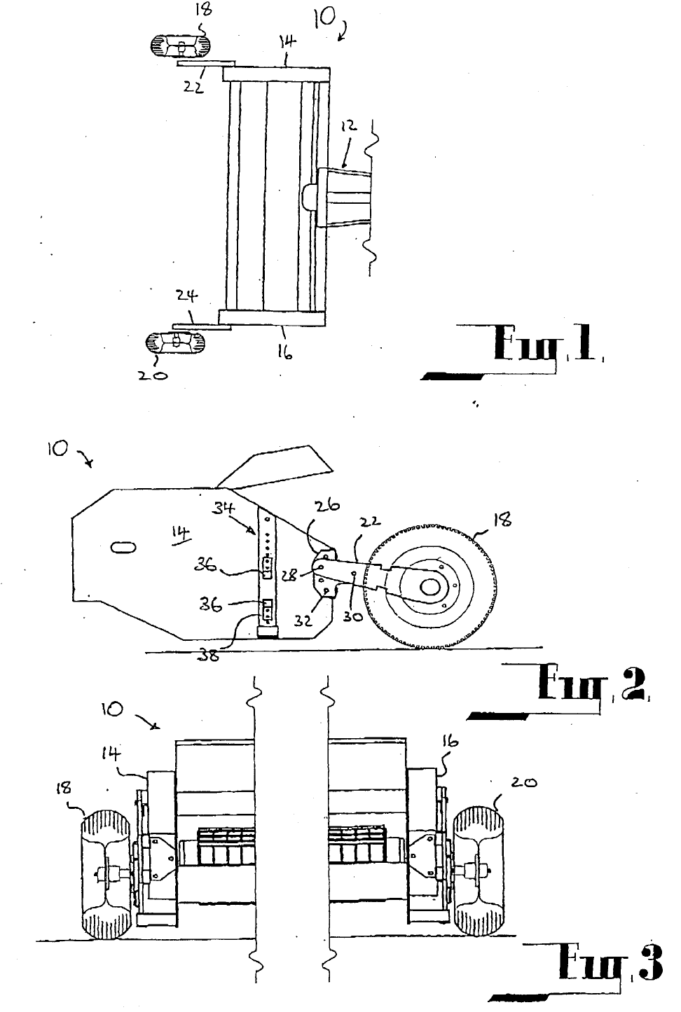

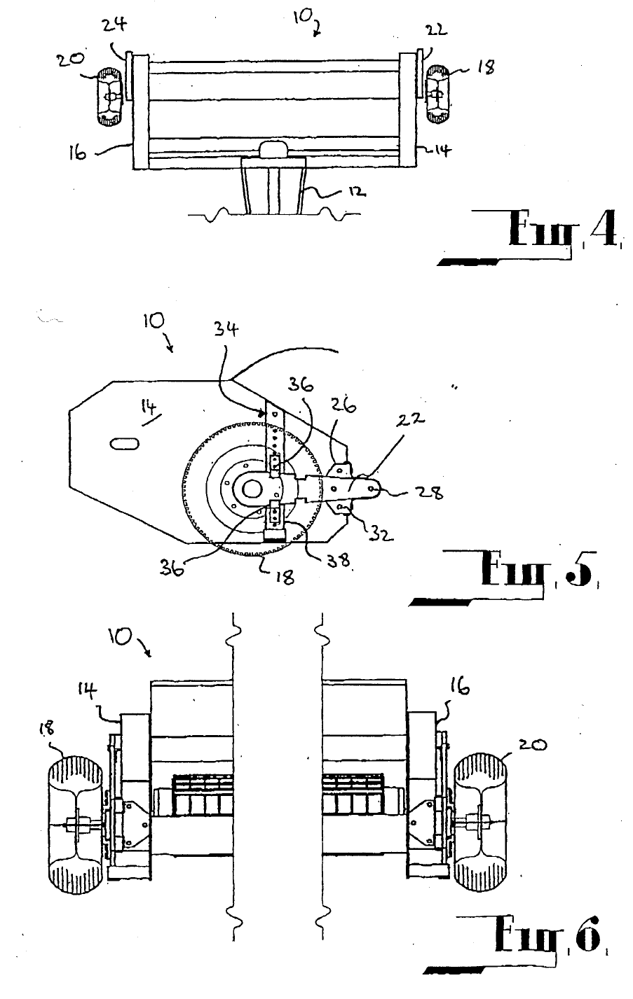

In FIGS. 1 to 9 there is shown a threshing machine 10 on which is provided a towing arm arrangement 12 which is utilised to tow the machine 10 in its operational configuration, as shown specifically in FIGS. 1 and 4.

The threshing machine 10 comprises end plates 14 and 16. A pair of wheels 18 is provided to support the threshing machine 10, each wheel 18 and 20 being supported in a rotational manner by a wheel support arm 22 or 24 respectively. Each support arm 22 or 24 is pivotally connected to the thresher machine 10 by way of a mounting arrangement comprising a substantially T-shaped plate 26 hingedly connected to a corner of the thresher machine 10. This mounting arrangement is akin to a castor mounting of each wheel 18 and 20 with respect to the machine 10 when in the “wheels-trailing” arrangement shown in FIGS. 1 to 3.

Each support arm 22 and 24 has provided therein at least two apertures 28 and 30, the bracket 26 being provided with a plurality of apertures 32 and the support arms 22 and 24 being releasably attachable to the plate 26 through use of fastening means, for example bolts (not shown) passing through these apertures.

The specific orientation of the support arms 22 and 24 with respect to the brackets 26 is adjustable. In effect, the height of the machine 10 above a surface over which the machine is passing may be adjusted through manipulation of the orientation of the support arms 22 and 24 with respect to the brackets 26. Further, the support arms 22 and 24 may “pivot” about the aperture 30 and the fastening means provided therethrough with the specific arrangement being locked into place by use of a similar fastening means through the aperture 28 and one of the apertures 32 in the bracket 26.

When in the “wheels-trailing” orientation as shown in FIGS. 1 to 3 the plate 26 is hingedly attached to its respective plate 14 or 16 allowing “castoring” of the wheels 18 and 20 with respect to the machine 10 as a whole. In this arrangement the support arms 22 and 24 with the respective brackets 26 are effectively a mirror image of one another.

In the “wheels in-line” orientation of FIGS. 4 to 6 the orientation of the support arms 22 and 24 with respect to the brackets 26 has been inverted such that the support arms 22 and 24 extend forwardly of the brackets 26. The brackets 26 remain fixed to the plates 14 and 16 in a substantially parallel manner. As such, the wheels 18 and 20, and the support arms 22 and 24, are unable to “castor” with respect to the machine 10 in this arrangement.

The wheel support arms 22 and 24 are supported by a support means 34 comprising a pair of brackets 36 between which the support arm 22 or 24 is held. The brackets 36 each are adjustably mounted on a base support 38 affixed to the respective plates 14 and 16, the brackets 36 being incrementably adjustable with respect to the base support 38. Each support arm 22 and 24 is affixed to the bracket 26 at one point allowing pivotal manipulation of the arms 22 and 24 with respect thereto, whereby the desired incremental adjustment of the level of the support arms 22 and 24 may be achieved by way of the additional support means 34. This arrangement allows accurate control of the positioning of the rotor of the threshing machine 1 0 with respect to a crop or stubble in which such is being used as the wheels 18 and 20 are effectively “in-line” with the rotor 10. In this manner, the rotor 10 travels over the same ground as do the wheels 18 and 20, thereby the height adjustment made with respect to the wheels 18 and 20 is an accurate measure of the rotor height.

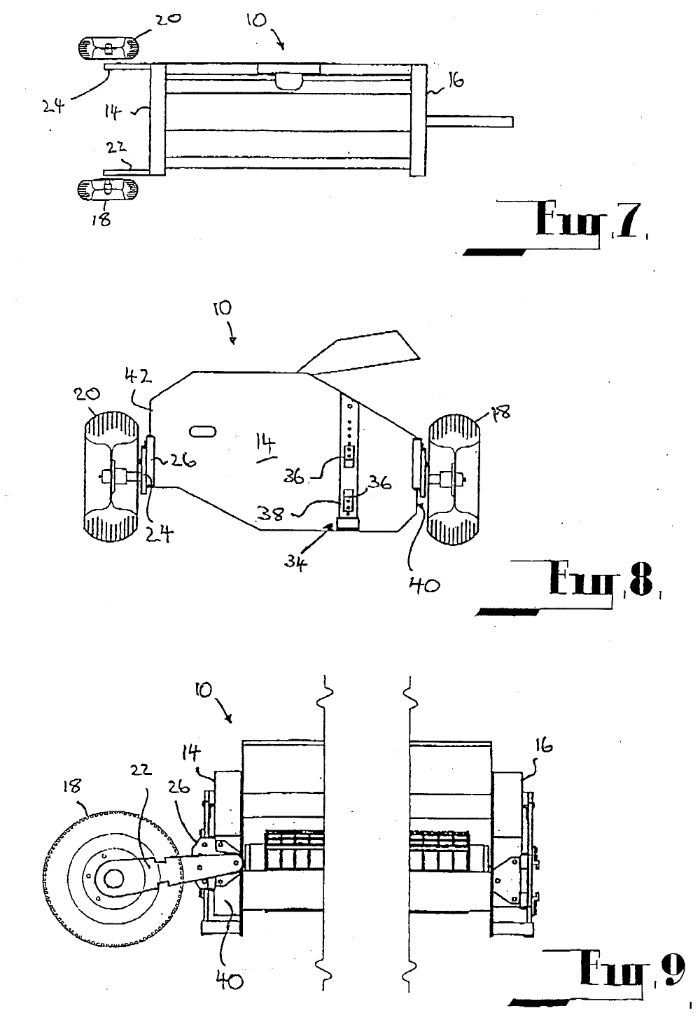

The orientation of the thresher machine 10 shown in FIGS. 7 to 9 is that preferred for transport on normal roads and through other obstacles including gates and the like. This arrangement requires that the bracket 26 to which the support arm 22 is attached be released from the plate 14 and the support means 34 if applicable. From here the bracket 26 and the support arm 22 attached thereto is rotated through 90° with respect to its pivotal connection to the thresher machine 10 such that the orientation shown in FIG. 9 is adopted, in which the plate 26 is now affixed to a rear wall 40 of the plate 14 in a releasable manner.

The support arm 24 and its plate 26 are simply detached from the plate 16 and are attached to a forward face 42 of the plate 14. In this orientation both support arms 22 and 24 project at a 90° angle to the plate 14, as shown in FIGS. 7 to 9, thereby allowing transport of the thresher machine 10 in its longitudinal orientation. Additional tie-bars (not shown) can be provided extending from the arms 22 and 24 to the rear of the machine 10 to ensure constant and predictable tracking of the machine 10 without “castoring” of the wheels 18 and 20.

Modifications and variations such as would be apparent to the skilled addressee are considered to fall within the scope of the present invention.

The claims defining the invention are as follows:

1. A mounting arrangement comprising at least one plate hingedly connected to an article of machinery, the plate having attached thereto a wheel support arm in a releasable and adjustable manner, the plate being able to pivot with respect to the article of machinery such that the orientation of the wheel arm with respect thereto may be altered and fixed in one of at least two differing positions.

2. A mounting arrangement as claimed in claim 1 wherein the means by which the wheel arm is attached to the plate is adjustable so as to allow the height from ground of the article of machinery to be adjusted thereby.

3. A mounting arrangement as claimed in claim 2 wherein the means by which the wheel arm is attached to the plate is incrementally adjustable so as to allow the height from ground of the article of machinery to be adjusted thereby.

4. A mounting arrangement comprising at least one plate to which is attached a wheel support arm in a releasable and adjustable manner, the orientation of the wheel arm with respect to the bracket being able to be adjusted so as to allow the wheel arm to be adjusted between both a “wheels-trailing” orientation and a “wheels in-line” orientation.

5. A mounting arrangement as claimed in claim 4 wherein when the wheel support arm is in said “wheels in-line” orientation, an additional support means is provided, said additional support means operating to fix the wheel support arm at a particular height so as to allow adjustment of the height of the article of machinery with respect to a surface over which it is passing.

6. A mounting arrangement as claimed in claim 5 wherein said additional support means comprises a pair of vertically adjustable brackets in between which the wheels support arm may be held.

7. A mounting arrangement as claimed in claim 6 wherein said pair of vertically adjustable brackets are incrementally adjustable.

8. An elongate article of machinery supported from the ground on at least two wheels, said machinery having a mounting arrangement located at or near one corner thereof, for receiving a wheel arm which may be oriented and fixed in one of at least two different positions, and a mounting arrangement mountable at or near each adjacent corner for receiving a second wheel arm, where said machinery may be deployed with said wheel arm and said second wheel arm located distally, and said machinery may be transported with said wheel arm and said second wheel arm located proximally.

9. A mounting arrangement substantially as herein described with reference to the drawings.
